(19) United States
(12) Patent Application Publication
(10) Pub. No.: US 2026/0213462 A1
(43) Pub. Date: Jul. 23, 2026

(54) CONNECTOR POSITION ASSURANCE WITH INTERLOCK FUNCTION

(71) Applicant: FCI USA LLC, Etters, PA (US)

(72) Inventors: Chien Chen Lo, Taoyuan City (TW); Shang Wei Chen, Taoyuan City (TW); Chun-Hsiang Fu, Taoyuan City (TW)

(73) Assignee: FCI USA LLC, Etters, PA (US)

(21) Appl. No.: 19/571,723

(22) Filed: Mar. 19, 2026

Related U.S. Application Data
(60) Provisional application No. 63/880,229, filed on Sep. 11, 2025.

(51) Int. Cl. H01R 13/641; H01R 13/627; H01R 43/26

(52) U.S. Cl. CPC H01R 13/641; H01R 13/6275; H01R 43/26

(57) ABSTRACT

A power connector suitable for use in a high power compute rack. A system using the power connector systems may implement HVIL by means of a CPA of the power connector to ensure and reliable connection in a small space. Reliable connection is ensured through the use of an electrical connector system configurable in: a first state wherein a CPA is attached to a first connector, a second state wherein the first connector is mated to a second connector, and a third state wherein a conductive member electrically connects interlock terminals.

### CROSS-REFERENCE TO RELATED APPLICATIONS

This application claims benefit under 35 U.S.C. § 119(e) of U.S. Provisional Application Ser. No. 63/880,229, filed Sep. 11, 2025, and titled “CONNECTOR POSITION ASSURANCE WITH INTERLOCK FUNCTION,” which is incorporated herein by reference in its entirety.

### BACKGROUND

Electrical connectors may facilitate transfer of electrical power. Electrical connectors may transfer electrical power at high voltages.

### SUMMARY

According to an aspect of the technology, an electrical connector system configurable in a first state, a second state, and a third state is provided. The electrical connector system comprises a first housing, a second housing configured to mate with the first housing in a mating direction, a connector position assurance (CPA) configured to movably attach to the first housing, a conductive member, a first sense lead, and a second sense lead. In the first state: the CPA is attached to the first housing. In the second state: the CPA is attached to the first housing and the first housing is mated to the second housing. In the third state: the CPA is attached to the first housing, the first housing is mated to the second housing and the conductive member electrically connects the first sense lead to the second sense lead.

According to an aspect of the technology, a first electrical connector configured to mate with a second electrical connector is provided. The first electrical connector comprises a housing, terminals configured to mate with respective terminals of the second electrical connector in a mating direction, a connector position assurance (CPA) configured to couple to the first electrical connector and slide in the mating direction to an engaged position. The first electrical connector is configured such that an electrical connection is made between sense leads of an interlock circuit when the CPA is in the engaged position. The housing is configured such that the CPA is blocked by the housing from sliding into the engaged position when the terminals are not mated with respective terminals of the second electrical connector.

According to an aspect of the technology, a method of connecting and disconnecting an electrical connector system including a first electrical connector, a second electrical connector, and a connector position assurance (CPA) is provided. The method comprises latching the first electrical connector to the second electrical connector by mating the first electrical connector to the second electrical connector in a mating direction and engaging a latch of the first electrical connector with a complementary latching feature of the second connector. The method further comprises electrically connecting a first sense lead to a second sense lead by sliding the CPA.

### BRIEF DESCRIPTION OF DRAWINGS

Various aspects and embodiments of the technology will be described with reference to the following figures. The figures are not necessarily drawn to scale.

FIG. 1A is a perspective view of an electrical connector system including a plug, a receptacle, and a CPA, according to some embodiments.

FIG. 1B is a cross-sectional side view of the electrical connector system of FIG. 1A.

FIG. 2A is a perspective view of the plug of FIG. 1A.

FIG. 2B is a mating interface view of the plug of FIG. 1A.

FIG. 2C is a rear view of the plug of FIG. 1A.

FIG. 2D is a side view of the plug of FIG. 1A.

FIG. 2E is a further perspective view of the plug of FIG. 1A.

FIG. 2F is a bottom view of the plug of FIG. 1A.

FIG. 2G is a cross-sectional side view of the receptacle of FIG. 1A.

FIG. 3A is a perspective view of the receptacle of FIG. 1A.

FIG. 3B is a mating interface view of the receptacle of FIG. 1A.

FIG. 3C is a rear view of the receptacle of FIG. 1A.

FIG. 3D is a side view of the receptacle of FIG. 1A.

FIG. 3E is a top view of the receptacle of FIG. 1A.

FIG. 3F is a cross-sectional side view of the receptacle of FIG. 1A.

FIG. 4A is a perspective view of the CPA of FIG. 1A.

FIG. 4B is a mating interface view of the CPA of FIG. 1A.

FIG. 4C is a rear view of the CPA of FIG. 1A.

FIG. 4D is a side view of the CPA of FIG. 1A.

FIG. 4E is a top view of the CPA of FIG. 1A.

FIG. 4F is a bottom view of the CPA of FIG. 1A.

FIG. 5 is a top view of the electrical connector system of FIG. 1A in a zeroth position, according to some embodiments.

FIG. 6A is a top view of the electrical connector system of FIG. 1A in a first position, according to some embodiments.

FIG. 6B is a cross-sectional top view of the electrical connector system of FIG. 1A in the first position.

FIG. 6C is a cross-sectional side view of the electrical connector system of FIG. 1A in the first position.

FIG. 7A is a top view of the electrical connector system of FIG. 1A in a second position, according to some embodiments.

FIG. 7B is a cross-sectional top view of the electrical connector system of FIG. 1A in the second position.

FIG. 7C is a cross-sectional side view of the electrical connector system of FIG. 1A in the second position.

FIG. 8A is a top view of the electrical connector system of FIG. 1A in a third position, according to some embodiments.

FIG. 8B is a cross-sectional top view of the electrical connector system of FIG. 1A in the third position.

FIG. 8C is a cross-sectional side view of the electrical connector system of FIG. 1A in the third position.

### DETAILED DESCRIPTION

Described herein are techniques for providing high power connectors that enhance safety of people working with or near the high power connections, while providing reliable operation in a constrained space. Such connectors, for example, may be used in equipment racks in data centers to deliver power to electronics inside the rack.

In some examples, a power connector may include a connector position assurance member that slides between an engaged, or locked, position and a disengaged, or unlocked, position. In the engaged position, the CPA may block motion of a latch for transitioning a mating connector into an unlatched state. The CPA may include a conductive structure that completes a signaling circuit only when in the engaged position. The CPA may be configured to be blocked from entering the engaged position unless the power connector is mated with a mating connector such that the signaling circuit is completed when the mating interface of the power connector is blocked by the mating connector.

In some examples, a simple sliding motion of the CPA into the engaged position provides assurance that the connector is properly mated and latched, restricts unintended unlatching of the connector from a mating connector, and generates a signal that may be used as a high voltage interlock signal. The CPA and latch may fit in a relatively small space and may effectively operate even with a relatively small clearance around that space. Nonetheless, moving the CPA into the engaged position may signal to an operator that the power connector is properly mated and signal to the system that power circuits through the connector may be energized. Moving the CPA into the engaged position resists disconnection of the power connector from a mating connector, even for a latch that occupies a relatively small space.

Additionally, the inventors have appreciated that some electrical connector systems may be installed in a location with limited space or clearance in a direction transverse to a mating direction. Accordingly, the inventors have recognized that it may be advantageous to provide for CPAs with interlock function which engage by sliding in a mating direction. As used herein, specification of movement “in” a “direction” (e.g., the mating direction, a direction transverse to the mating direction) encompasses movement both in and opposite to that direction (e.g., such that, in an x-y-z coordinate plane, movement both in the positive x-direction and in the negative x-direction qualifies as in the x-direction) unless context clearly indicates to the contrary.

Following below is further detailed description of embodiments applying concepts relating to electrical connectors implementing CPAs with interlock function. Aspects described herein may be implemented in numerous ways; examples of specific implementations are provided herein for illustrative purposes only.

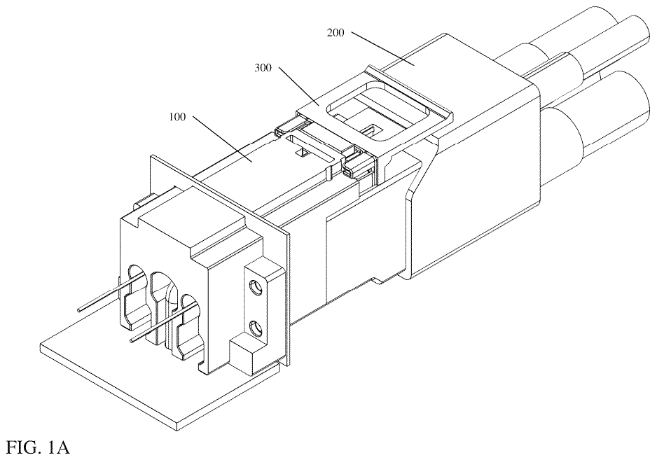

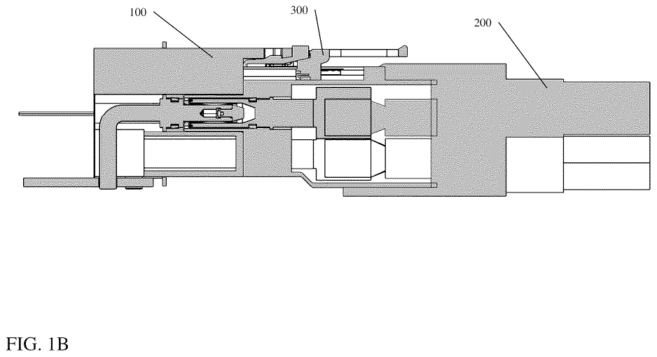

FIG. 1A is a perspective view of an electrical connector system including a plug 100, a receptacle 200, and a CPA 300. FIG. 1B is a cross-sectional side view of the electrical connector system. The electrical connector system is shown mated with the CPA 300 engaged such that an HVIL circuit is closed and electrical power may flow between the plug 100 and the receptacle 200.

As further described herein, the electrical connector system may not be unmated without first disengaging the CPA 300. Because disengaging the CPA 300 opens the HVIL circuit—which opening in turn prevents the flow of electrical power between the plug 100 and the receptacle 200—an operator may safely unmate the electrical connector system without being exposed to hazardous voltages within the plug 100 and the receptacle 200.

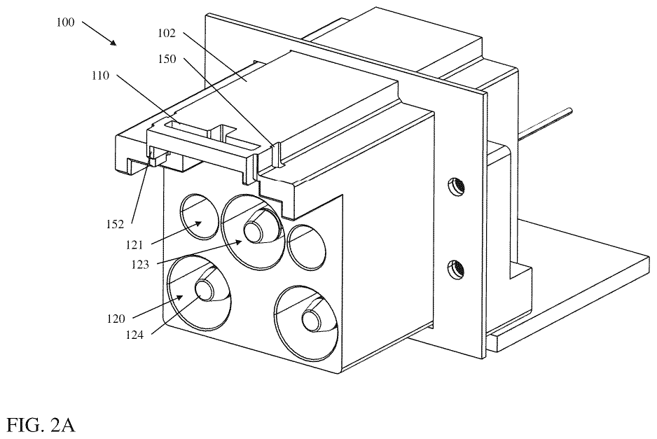

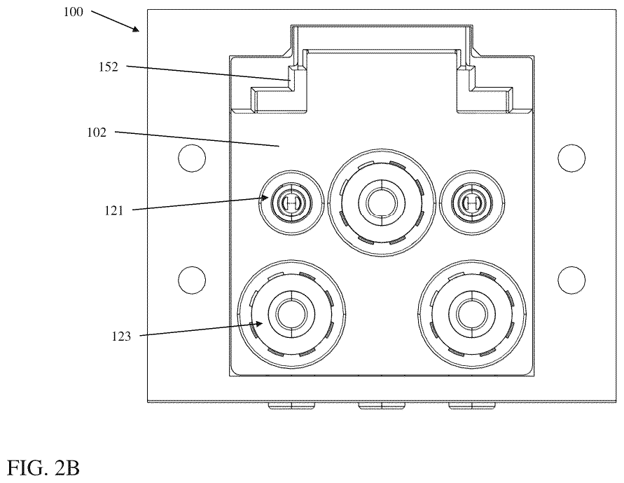

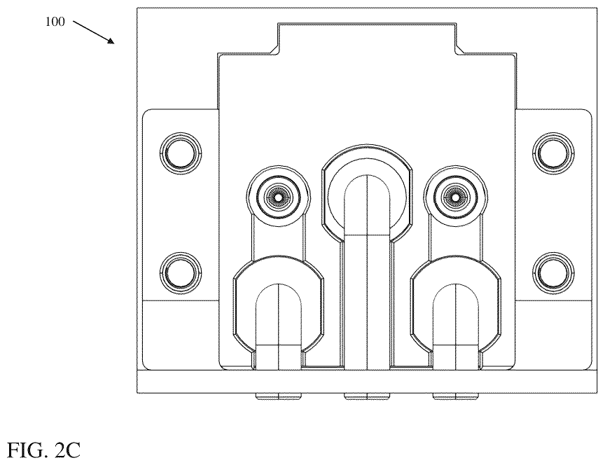

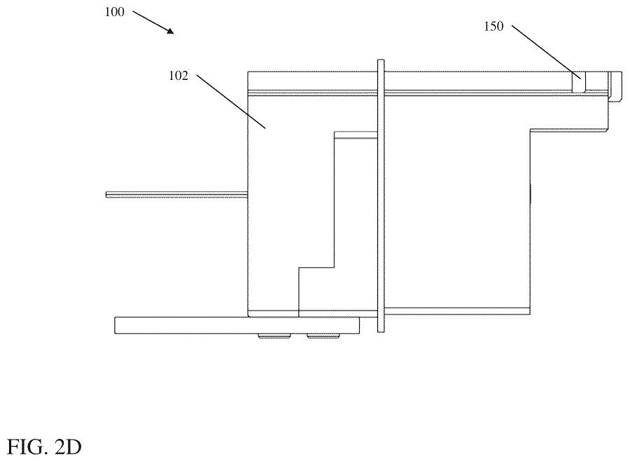

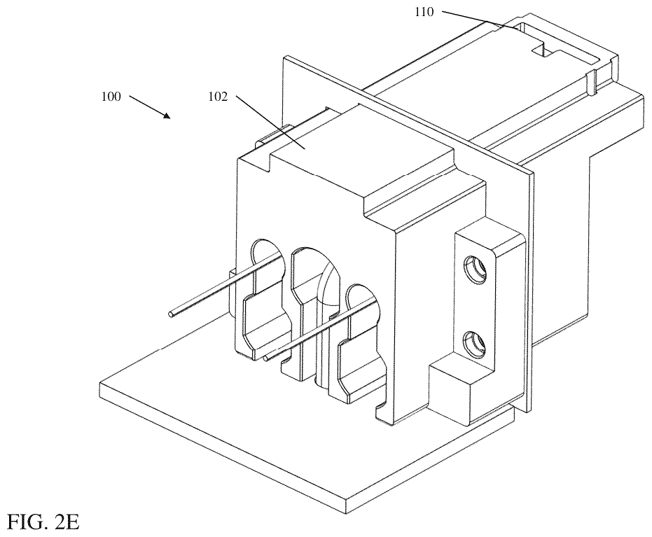

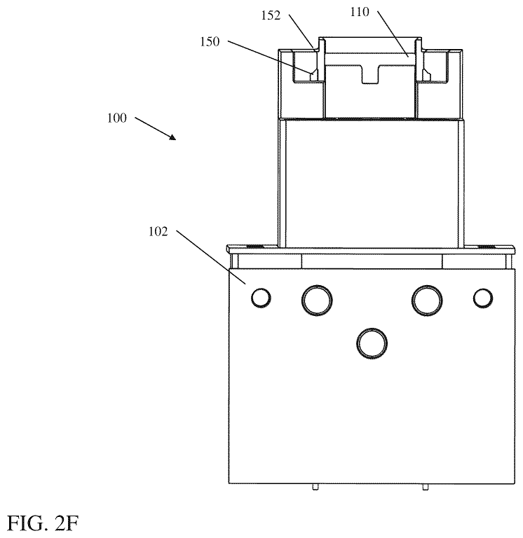

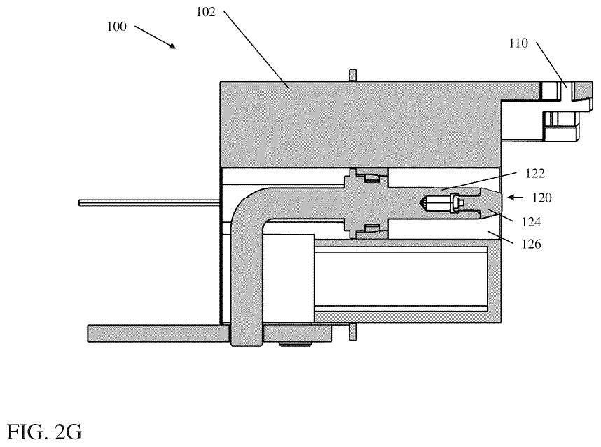

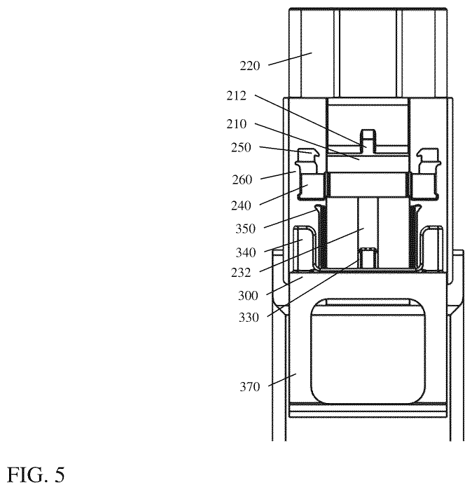

For ease of understanding, each of the plug 100, the receptacle 200, and the CPA 300 are further described primarily in conjunction with FIGS. 2A-2G, FIGS. 3A-3F, and FIGS. 4A-4F, respectively. Thereafter, mating and unmating processes of the electrical connector system are further described primarily in conjunction with FIGS. 5-8C.

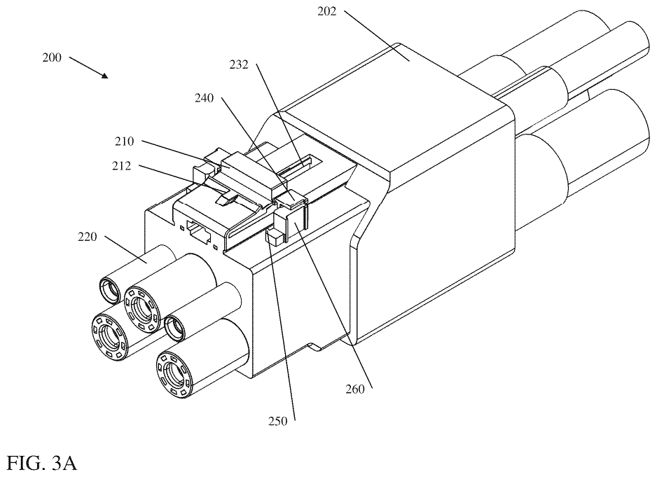

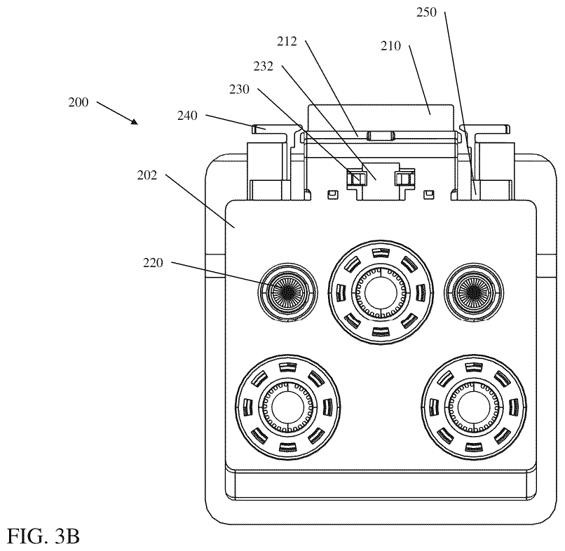

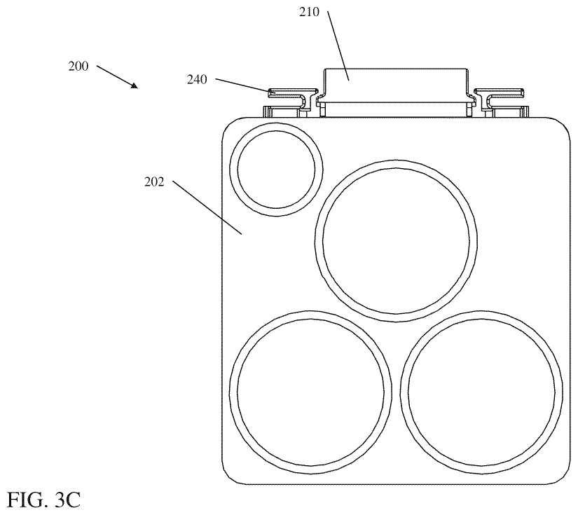

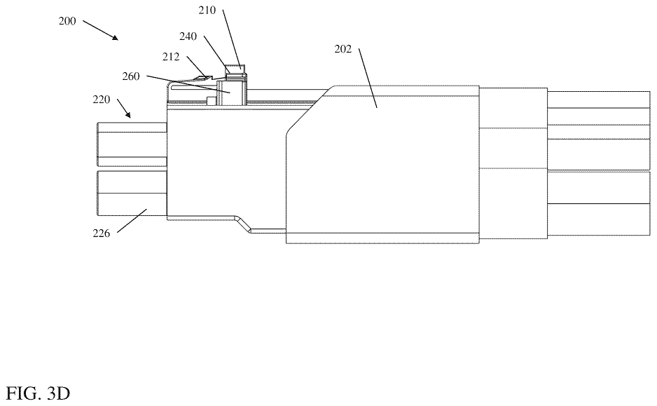

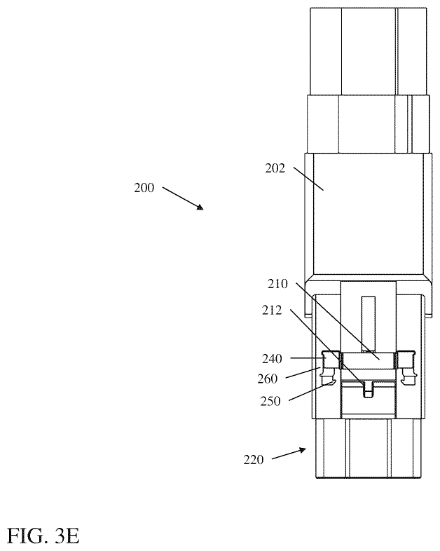

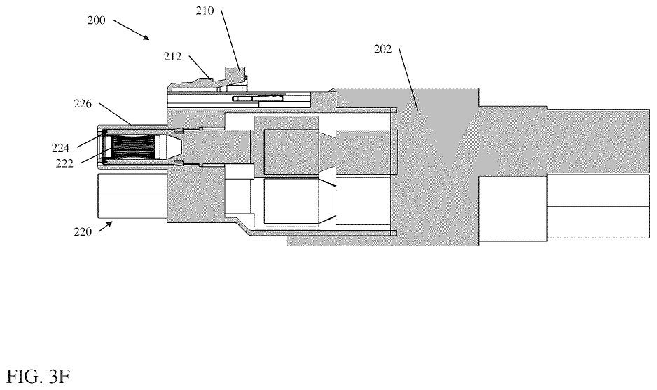

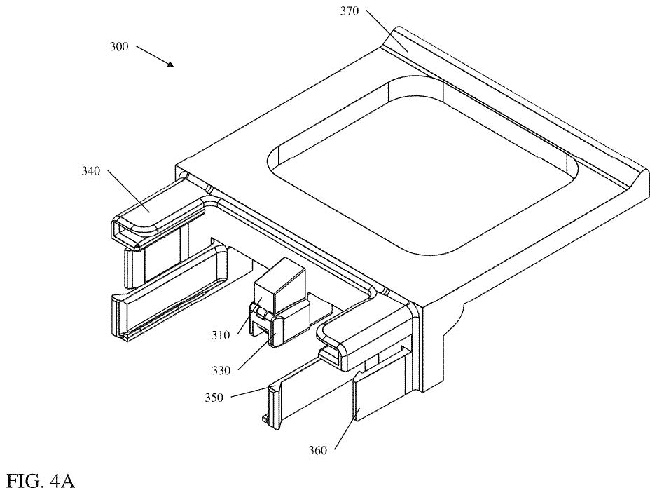

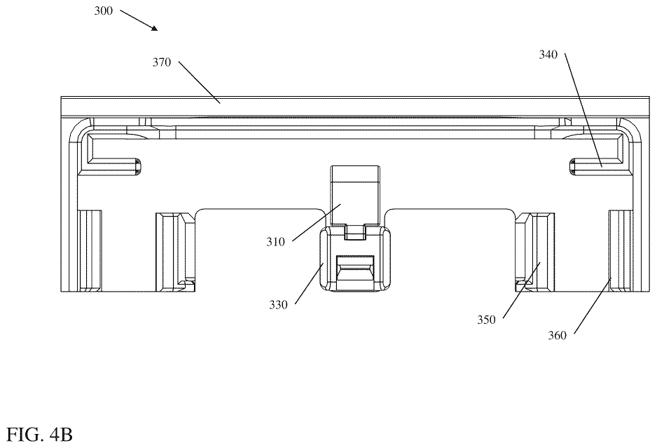

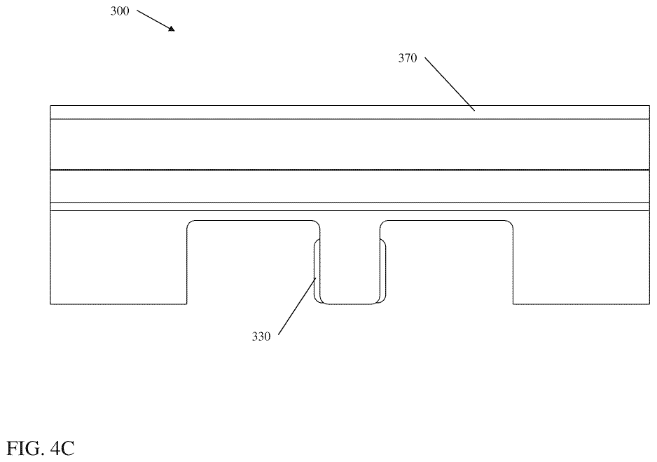

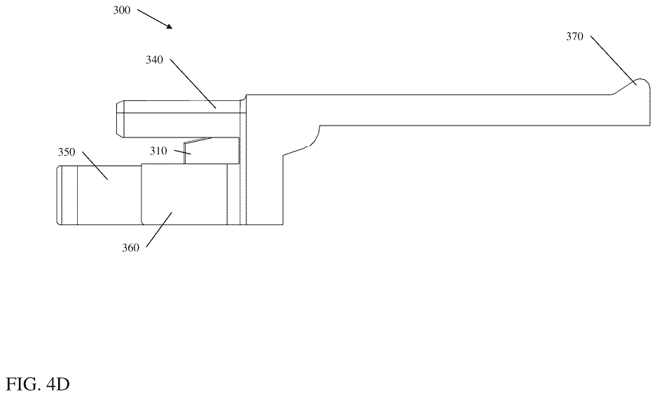

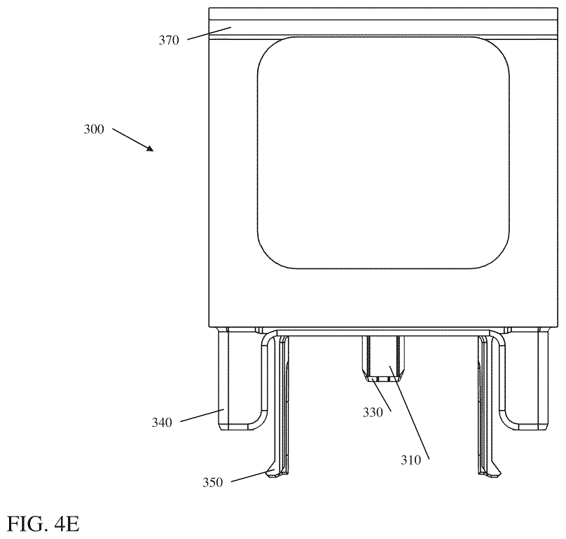

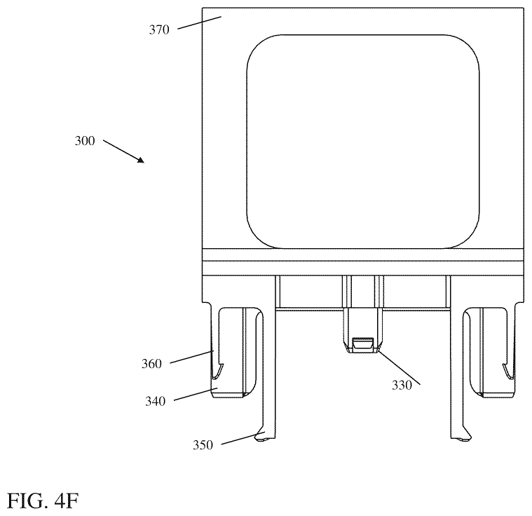

In general, reference characters beginning with “1” are primarily associated with the plug 100 and thus shown in FIGS. 2A-2G, reference characters beginning with “2” are primarily associated with the receptacle 200 and thus shown in FIGS. 3A-3F, and reference characters beginning with “3” are primarily associated with the CPA 300 and thus shown in FIGS. 4A-4F. Reference characters used in description of figures in which an associated component itself is not shown are non-limiting examples invoked to further describe the interaction of components of plugs, receptacles, and/or CPAs according to the technology disclosed herein.

FIGS. 2A-2G are various views of the plug 100: FIG. 2A is a perspective view, FIG. 2B is a mating interface view, FIG. 2C is a rear view, FIG. 2D is a side view, FIG. 2E is a further perspective view, FIG. 2F is a bottom view, and FIG. 2G is a cross-sectional side view.

As shown, the plug 100 includes a slot 110, terminals 120, a recess 150, and a bevel 152. The plug 100 may include electrically conductive and electrically insulative materials. In some embodiments, the plug 100 may include a housing 102 serving to secure, protect, and/or insulate electrically conductive elements within the housing 102.

The terminals 120 may be disposed on, and/or may define, a mating interface of the plug 100. The terminals 120 may have shapes complementary to shapes of terminals 220 of the receptacle 200 to allow mating of the terminals 120 to respective terminals 220 when the plug 100 is mated to the receptacle 200. The number of terminals 120 may correspond to the number of terminals 220 and may be based on an electrical system of which the plug 100 and the receptacle 200 are a part. The terminals 120 may include signal terminals 121 and/or power terminals 123. In some embodiments, the signal terminals 121 may be of a different shape than the power terminals 123. For example, the signal terminals 121 may have a smaller diameter than the power terminals 123.

The terminals 120 may include conductive elements 122 configured to electrically contact conductive elements of terminals 220 of the receptacle 200 when the plug 100 is mated to the receptacle 200. may be configured to transmit and/or receive electrical signals and/or electrical power to and/or from the terminals 220 of the receptacle 200. The conductive elements 122 may include conductive materials such as metals and/or metal alloys. For example, the conductive elements 122 may include copper.

The terminals 120 may include touchproof caps 124 disposed on the conductive elements 122. The touchproof caps 124 may be configured to protect a user from direct contact with the conductive elements 122. The touchproof caps 124 may include electrically insulative materials. For example, the touchproof caps 124 may include a polymer.

The terminals 120 may include cavities 126 in which the conductive elements 122 and/or the touchproof caps 124 are disposed; the cavities 126 may be recesses of the housing 102.

As described, the terminals 120 may be disposed on, and/or may define, a mating interface of the plug 100. For example, a layout of the terminals 120 on the housing 102 may define a mating interface of the plug as the layout of the terminals 120 may determine whether a given receptacle may mate with the plug 100. In some embodiments, the mating interface may include terminals 120 arranged as follows: a first row including two power terminals 123 disposed in respective corners of the mating interface; a second row including a power terminal 123 disposed between two signal terminals 121. The two signal terminals 121 may be aligned with the two power terminals 123 of the first row in a column direction perpendicular to a direction of the first row.

The slot 110 may be configured to engage with a component of the receptacle 200 when the plug 100 is mated to the receptacle 200. For example, the slot 110 may be configured to receive a projection 212 of a latch 210 of the receptacle 200. In some embodiments, the slot 110 may be configured such that the slot 110 may not be disengaged from the projection 212 without actuation of the latch 210. The slot 110 may thereby serve to prevent unintentional unmating of the plug 100 from the receptacle 200. The slot 110 may be of any suitable shape. For example, the slot 110 may have a shape complementary to a shape of the projection 212. In some embodiments, the slot 110 may elongated in a direction which is parallel to the mating interface.

The recess 150 may receive a component of the CPA 300 when the CPA 300 is in an engaged state. For example, the recess 150 may receive an inner latch 350 of the CPA 300.

The bevel 152 may be positioned in correspondence with the recess 150. The bevel 152 may include a surface which is neither parallel nor perpendicular to a mating direction of the plug 100. In some embodiments and as further described herein, the bevel 152 may serve to deflect the inner latch 350 in a direction transverse to a mating direction to permit the CPA 300 to transition to the engaged state such that the inner latch 350 is received in the recess 150.

FIGS. 3A-3F are various views of the receptacle 200: FIG. 3A is a perspective view, FIG. 3B is a mating interface view, FIG. 3C is a rear view, FIG. 3D is a side view, FIG. 3E is a top view, and FIG. 3F is a cross-sectional side view.

As shown, the receptacle 200 includes the latch 210, the projection 212, the terminals 220, sense leads 230, a slot 232, a guide rail 240, a protrusion 250, and a recess 260. The receptacle 200 may include electrically conductive and electrically insulative materials. In some embodiments, the receptacle 200 may include a housing 202 service to secure, protect, and/or insulate electrically conductive elements within the housing 202.

The projection 212 may be configured to engage with a component of the plug 100 when the receptacle 200 is mated to the plug 100. For example, the projection 212 may be configured to engage with the slot 110 of the plug 100. The projection 212 may be disposed on the latch 210.

The latch 210 may be actuatable to release the projection 212 from a component of the plug 100 with which the projection 212 is engaged. For example, the latch 210 may extend from a main body of the receptacle 200 such that force applied to a far end of the latch 210 may cause the latch 210 to deflect towards the main body of the receptacle 200.

The terminals 220 may be disposed on a mating interface of the receptacle 200. The terminals 220 may include signal terminals 221 and/or power terminals 223. The terminals 220 may include conductive elements 222 configured to electrically contact the conductive elements 122 of the terminals 120, touchproof caps 224 configured to protect a user from direct contact with the conductive elements 222, and protrusions 226 in which the conductive elements 222 are disposed and which are configured to be inserted into the cavities 126 of the terminals 120. As described above, the terminals 220 may have shapes complementary to shapes of terminals 120 to allow mating of the terminals 220 to respective terminals 120 when the receptacle 200 is mated to the plug 100. For example, the terminals 220 may define a mating interface complementary to a mating interface of the plug 100. The terminals 220 may be socket terminals.

The sense leads 230 may be conductive elements which are components of an HVIL circuit. The sense leads 230 may be configured such that an electrical connection between the sense leads 230 completes the HVIL circuit, which may permit electrical signals and/or power to transmit between the plug 100 and the receptacle 200. The sense leads 230 may be disposed such that an electrical connection between the sense leads 230 is made by a shorting member 330 of the CPA 300 when the CPA is in an engaged state.

The slot 232 may be configured to receive a component of the CPA 300. For example, the shorting member 330 of the CPA 300 may be disposed in the slot 232 when the CPA 300 is in the engaged state and/or before the CPA 300 transitions to the engaged state. The slot 232 may extend in a mating direction of the receptacle 200. In some embodiments, a component of the CPA 300 disposed in the slot 232 may slide within the slot 232 in the mating direction, as further described herein.

The guide rail 240 may engage with a component of the CPA 300 to facilitate positioning of the CPA 300. In some embodiments, the guide rail 240 may be configured complementarily to a guide rail 340 of the CPA.

The protrusion 250 may block motion of the CPA 300 in the mating direction until the plug 100 is mated to the receptacle 200. For example and as further described herein, the protrusion 250 may engage with an inner latch 350 of the CPA.

The recess 260 may receive a component of the CPA 300 to prevent withdrawal of the CPA 300 from the receptacle 200 after the CPA 300 has been coupled to the receptacle 200, as further described herein. For example, the recess 260 may receive an outer latch 360 of the CPA 300. Engagement between the recess 260 and the outer latch 360 of the CPA 300 may retain the CPA 300 in the receptacle 200 by preventing detachment of the CPA 300 from the receptacle 200. The recess 260 may include two stops. A stop proximate to the mating interface of the receptacle 200 may prevent motion of the CPA 300 past an engaged state of the CPA 300 in the mating direction towards the mating interface. A stop distal to the mating interface of the receptacle 200 may prevent decoupling of the CPA 300 from the receptacle 200, for example by preventing motion of the CPA 300 in the mating direction away from the mating interface.

FIGS. 4A-4F are various views of the CPA 300: FIG. 4A is a perspective view, FIG. 4B is a mating interface view, FIG. 4C is a rear view, FIG. 4D is a side view, FIG. 4E is a top view, and FIG. 4F is a bottom view.

As shown, the CPA 300 includes a protrusion 310, the shorting member 330, the guide rail 340, the inner latch 350, the outer latch 360, and the handle 370. The CPA 300 may be made of any suitable material.

The protrusion 310 may be configured to prevent actuation of the latch 210 of the receptacle 200 when the CPA 300 is in an engaged state. For example, when in the engaged state, the protrusion 310 may be disposed adjacent to the latch 210 such that force applied to the latch 210 does not deflect towards the main body of the receptacle 200.

The shorting member 330 may be configured to establish an electrical connection between the sense leads 230. The shorting member 330 may include any suitable electrically conductive material. In some embodiments, the shorting member 330 may have a predetermined electrical resistance to facilitate operation of an HVIL system of which the sense leads 230 are a component.

The guide rail 340 may be configured to facilitate coupling of the CPA 300 with the receptacle 200. For example, the guide rail 340 may engage with the guide rail 240 of the receptacle 200 to permit movement of the CPA 300 along a mating direction but not, for example, rotation and/or motion in a direction transverse to the mating direction.

The inner latch 350 may be configured to engage with a component of the receptacle 200 to prevent transition of the CPA 300 into an engaged state before the plug 100 is mated to the receptacle 200. For example, the inner latch 350 may be configured to engage with the protrusion 250.

The outer latch 360 may be configured to engage with a component of the receptacle 200 to prevent decoupling of the CPA 300 from the receptacle 200. For example, the outer latch 360 may be configured to be received by the recess 260 and blocked by a stop of the recess 260.

The handle 370 may be configured to be operable by an operator of the electrical connector system to engage and/or disengage the CPA 300. For example, the handle 370 may include a raised portion and/or a loop configured for convenient actuation by the operator.

Processes of mating and unmating the plug 100, the receptacle 200, and the CPA 300 are further described in conjunction with FIGS. 5-8C.

FIG. 5 is a top view of the electrical connector system in a zeroth state.

The electrical connector system may transition to the zeroth state by disposing a portion of the CPA 300 in a portion of the receptacle 200 configured to direct movement of the CPA 300.

In the zeroth state, the shorting member 330 may be disposed within the slot 232. However, the CPA 300 may not be attached to the receptacle 200; for example, the guide rail 340 of the CPA 300 may not be engaged with the guide rail 240 of the receptacle 200, and further the outer latch 360 of the CPA may not be received within the recess 260 of the receptacle 200.

The electrical connector system may transition from the zeroth state to an entirely unassembled state by removing the CPA 300 from the slot 232.

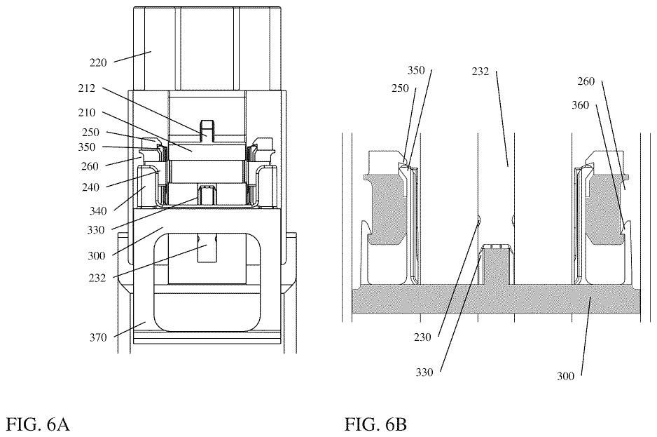

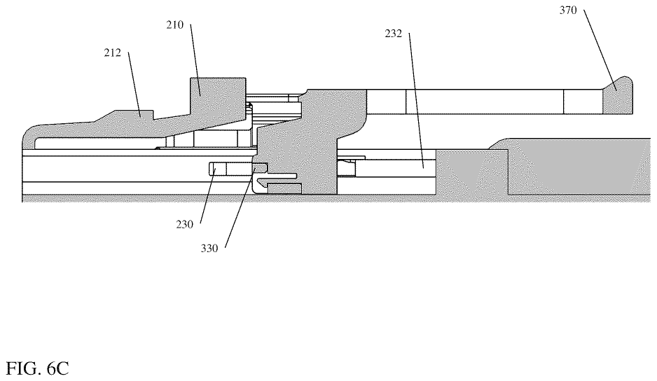

FIG. 6A is a top view of the electrical connector system in a first state. FIG. 6B is a cross-sectional top view of the electrical connector system in the first state. FIG. 6C is a cross-sectional side view of the electrical connector system in the first state.

The electrical connector system may transition from the zeroth state to the first state by sliding the CPA 300 in the mating direction towards the mating interface of the receptacle 200 such that the guide rail 340 of the CPA 300 engages the guide rail 240 of the receptacle 200.

In the first state, the CPA 300 may be attached to the receptacle 200. For example, the guide rail 340 of the CPA 300 may be engaged with the guide rail 240 of the receptacle 200.

In the first state, the inner latch 350 may be engaged with the protrusion 250. The protrusion 250 may prevent further motion of the CPA 300 in the mating direction toward the mating interface. Accordingly, the receptacle 200 may obstruct movement of the inner latch 350, and therefore the CPA 300, in the mating direction.

In the first state, the outer latch 360 may be received within the recess 260 of the receptacle 200. A stop of the recess 260 distal from the mating interface of the receptacle 200 may prevent motion of the CPA 300 in the mating direction away from the mating interface.

Accordingly, in the first state the CPA 300 may be unable to slide in the mating direction towards the mating interface (e.g., to bring the shorting member 330 in electrical contact with the sense leads 230) and away from the mating interface (e.g., to decouple the CPA 300 from the receptacle 200).

The electrical connector system may transition from the first state to the zeroth state by an operator manually deflecting the outer latch 360 and, while deflecting the outer latch 360, sliding the CPA 300 in the mating direction away from the mating interface.

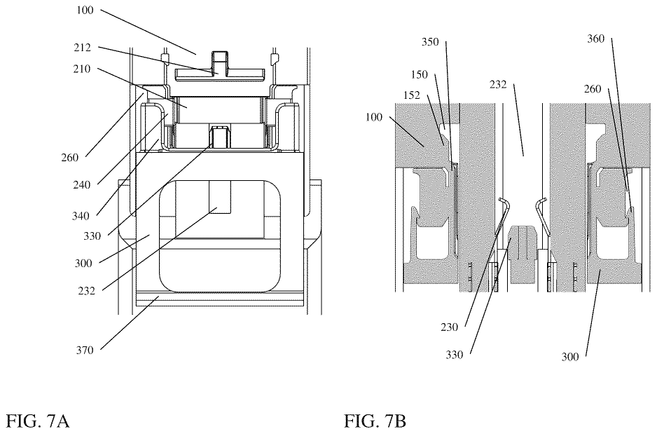

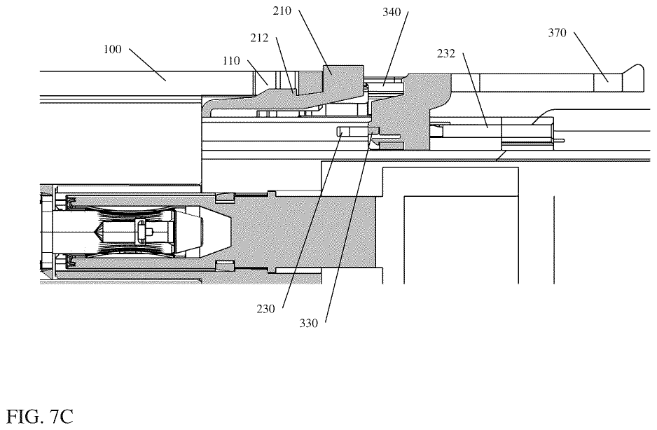

FIG. 7A is a top view of the electrical connector system in a second state. FIG. 7B is a cross-sectional top view of the electrical connector system in the second state. FIG. 7C is a cross-sectional side view of the electrical connector system in the second state.

The electrical connector system may transition from the first state to the second state by mating the plug 100 to the receptacle 200. Accordingly, mating of the plug 100 and the receptacle 200 may at least partially determine whether the electrical connector system is in the first state or the second state. Mating the plug 100 to the receptacle 200 may include moving the plug 100 and/or the receptacle 200 towards one another in the mating direction.

In the second state, the terminals 120 of the plug 100 may be mated with the terminals 220 of the receptacle 200.

In the second state, the inner latch 350 may not be engaged with the protrusion 250. For example, the plug 100 may be positioned such that, if the CPA 300 moves toward the mating interface, the inner latch 350 engages the bevel 152 rather than the protrusion 250. In contrast to the protrusion 250 which engages with the inner latch 350 to block movement of the CPA 300 toward the mating interface, the bevel 152 may be shaped such that the inner latch 350 deflects to permit movement of the CPA 300 toward the mating interface.

In the second state, the projection 212 of the receptacle 200 may be engaged with the slot 110 of the plug 100. Accordingly, upon entering the second state, engagement of the projection 212 and the slot 110 may prevent relative motion of the plug 100 away from the receptacle 200 such that mating the terminals 220 of the receptacle 200 to terminals 120 of the plug 100 may lock the receptacle 200 to the plug 100. However, the latch 210 may be actuatable to release the projection 212 from the slot 110 to permit such relative motion. Thus, a protrusion (e.g., the projection 212) of the receptacle 200 may engage with a gap (e.g., the slot 110) of the plug 100 to prevent unintentional de-mating of the receptacle 200 and the plug 100.

The electrical connector system may transition from the second state to the first state by an operator actuating the latch 210 to release the projection 212 from the slot 110 and, while actuating the latch 210, sliding the plug 100 and/or the receptacle 200 away from one another in the mating direction.

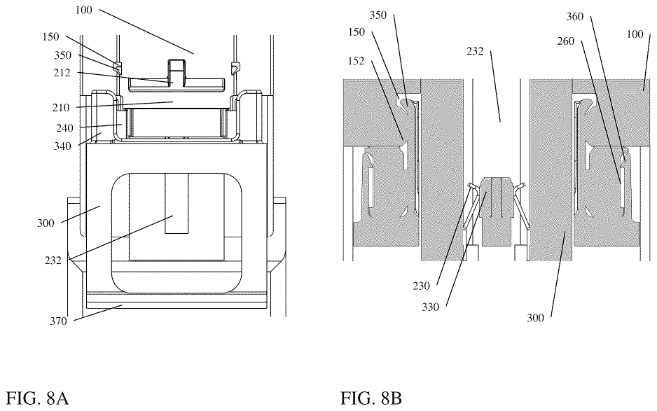

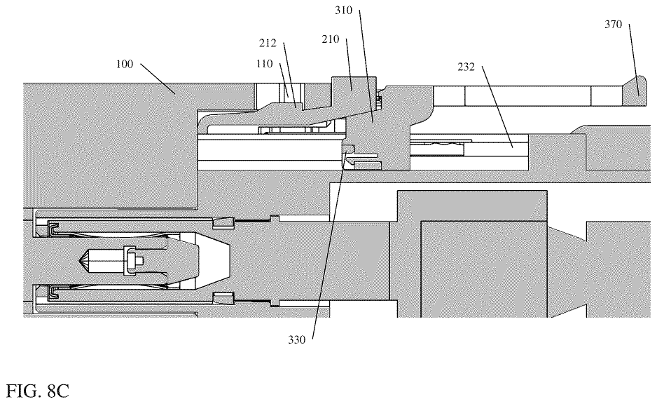

FIG. 8A is a top view of the electrical connector system in a third state. FIG. 8B is a cross-sectional top view of the electrical connector system in the third state. FIG. 8C is a cross-sectional side view of the electrical connector system in the third state.

The electrical connector system may transition from the second state to the third state by sliding the CPA 300 in the mating direction towards the mating interface of the receptacle 200 such that the shorting member 330 makes electrical contract with the sense leads 230. Accordingly, translation of the CPA 300 in the mating direction may at least partially determine whether the electrical connector system is in the second state or the third state.

In the third state, the shorting member 330 may be in electrical contact with the sense leads 230. Accordingly, the third state may close an HVIL circuit of a system in which the electrical connector system is integrated, thereby permitting electrical power and/or electrical signals to be transmitted through the terminals 120 of the plug 100 and the terminals 220 of the receptacle 200.

In the third state, the inner latch 350 may be disposed in the recess 150 of the plug 100. In some embodiments, the inner latch 350 may be visible from through the recess 150. The recess 150 may have a first stop distal from the CPA 300 which serves to prevent further motion of the CPA 300 in the mating direction toward the mating interface. In some embodiments, the recess 150 may have a second stop proximate to the CPA 300 which serves to prevent unintentional movement of the CPA 300 in the mating direction away from the mating interface (e.g., such as may otherwise occur from vibrations of the electrical connector system or an environment in which the electrical connector system is disposes); however, the second stop may be angled so as to permit movement of the CPA 300 in the mating direction away from the mating interface in response to a force sufficient to cause deflection of the inner latch 350.

In the third state, the protrusion 310 of the CPA 300 may block motion of the latch 210. Accordingly, in the third state it may be impossible for an operator of the electrical connector system to release the projection 212 from the slot 110. Thus, the electrical connector system may prevent the operator from being exposed to hazardous voltages of the terminals 120 of the plug 100 and the terminals 220 of the receptacle 200 while the electrical connector system is transmitting electrical power and/or electrical signals between the plug 100 and the receptacle 200. For example, the requirement that the electrical connector system transition through the second state in order to return to the first state ensures both that the HVIL circuit must be open to unmate the plug 100 and the receptacle 200 and that a period of time passes between the opening of the HVIL circuit and exposure of the terminals 120 of the plug 100 and the terminals 220 of the receptacle. This period of time ensures that no hazardous voltage remains in the terminals 120 of the plug 100 and/or the terminals 220 of the receptacle 200 by the time an operator is able to contact them.

The electrical connector system may transition from the third state to the second state by sliding the CPA 300 in the mating direction away from the mating interface.

Accordingly, in some embodiments an electrical connector system is provided in which HVIL is implemented by means of a CPA which transitions between states only by sliding in a mating direction of the electrical connector system.

Having thus described several aspects of at least one embodiment, various alterations, modifications, and improvements will readily occur to those skilled in the art. For example, an electrical connector system may be provided in which sense leads are disposed in a plug rather than a receptacle, or one sense lead may be disposed in each of the plug and the receptacle. Additionally, a latch of a plug may be configured to engage with a slot of a receptacle. Further, other complementary mating features may be used in addition to or in place of the latches, projections, slots, and protrusions described herein. As a yet further example, first and second features of a CPA may perform the functions of the first and second latches described herein regardless of classification as a “latch” and/or as respectively “inner” and “outer.” Still further, a CPA may be configured to attach to a plug in a first state rather than to a receptacle. Such alterations, modifications, and improvements are intended to be part of this disclosure and within the spirit and scope of the principles described herein. Accordingly, the foregoing description and drawings are by way of example only.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Use of ordinal terms such as “first,” “second,” “third,” et cetera, does not by itself connote any priority, precedence, or order of one element over another or the temporal order in which acts of a method are performed. Such terms are used merely as labels to distinguish one element having a certain name from another element having a same name (but for use of the ordinal term) to distinguish the elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. An electrical connector system configurable in a first state, a second state, and a third state, the electrical connector system comprising:
a first housing;
a second housing configured to mate with the first housing in a mating direction;
a connector position assurance (CPA) configured to movably attach to the first housing;
a conductive member;
a first sense lead; and
a second sense lead,
wherein:
in the first state:
the CPA is attached to the first housing;
in the second state:
the CPA is attached to the first housing; and
the first housing is mated to the second housing; and
in the third state:
the CPA is attached to the first housing;
the first housing is mated to the second housing; and
the conductive member electrically connects the first sense lead to the second sense lead.

2. The electrical connector system of claim 1, wherein the CPA comprises the conductive member.

3. The electrical connector system of claim 2, the CPA is configured to slide in the mating direction to transition the electrical connector system between the second state and the third state.

4. The electrical connector system of claim 3, wherein the first housing comprises a slot configured to receive the conductive member.

5. The electrical connector system of claim 4, wherein:
the first housing comprises the first sense lead; and
the first sense lead comprises a first conductive beam extending into the slot.

6. The electrical connector system of claim 5, wherein:
the first housing comprises the second sense lead; and
the second sense lead comprises a second conductive beam extending into the slot opposite the first conductive beam.

7. The electrical connector system of claim 1, wherein, in the second state, a protrusion of the first housing engages with a gap of the second housing to prevent de-mating of the first housing from the second housing.

8. The electrical connector system of claim 7, wherein, in the second state, the protrusion is actuatable via a motion perpendicular to the mating direction to disengage the protrusion from the gap and allow de-mating of the first housing from the second housing.

9. The electrical connector system of claim 8, wherein, in the third state, the CPA prevents actuation of the protrusion.

10. The electrical connector system of claim 1, wherein a first latch of the CPA is configured to prevent detachment of the CPA from the first housing in the mating direction when the electrical connector system is in the first state.

11. The electrical connector system of claim 10, wherein, in the first state, the first housing is configured to obstruct movement of a second latch of the CPA in the mating direction such that the electrical connector system cannot transition from the first state to the third state except via the second state.

12. The electrical connector system of claim 11, wherein, in the second state, the first housing does not obstruct movement of the second latch in the mating direction.

13. A first electrical connector configured to mate with a second electrical connector, the first electrical connector comprising:
a housing;
terminals configured to mate with respective terminals of the second electrical connector in a mating direction; and
a connector position assurance (CPA) configured to couple to the first electrical connector and slide to an engaged position;
wherein:
the first electrical connector is configured such that an electrical connection is made between sense leads of an interlock circuit when the CPA is in the engaged position; and
the housing is configured such that the CPA is blocked by the housing from sliding into the engaged position when the terminals are not mated with respective terminals of the second electrical connector.

14. The first electrical connector of claim 13, wherein:
the housing includes an actuator configured to release a mated second electrical connector; and
the CPA prevents actuation of the actuator when the CPA is in the engaged position.

15. The first electrical connector of claim 13, wherein the terminals of the first electrical connector comprise:
a plurality of signal terminals; and
a plurality of power terminals.

16. The first electrical connector of claim 15, wherein the terminals of the first electrical connector define a mating interface comprising:
a first row proximal to a first side of the mating interface and distal to a second side of the mating interface opposite the first side, the first row including:
a first power terminal disposed:
proximal to a third side of the mating interface; and
distal to a fourth side of the mating interface opposite the third side; and
a second power terminal disposed:
distal to the third side; and
proximal to the fourth side; and
a second row which is distal to the first side and proximal to the second side, the second row including a first signal terminal proximal to the third side, a second signal terminal proximal to the fourth side, and a third power terminal disposed between the first signal terminal and the second signal terminal.

17. The first electrical connector of claim 16, wherein:
the first signal terminal is aligned with the first power terminal in a column direction; and
the second signal terminal is aligned with the second power terminal in the column direction.

18. The first electrical connector of claim 13, wherein the CPA is configured to slide in the mating direction to the engaged position.

19. The first electrical connector of claim 18, wherein:
the housing comprises at least one housing guide rail; and
the CPA comprises at least one CPA guide rail configured to engage with the at least one housing guide rail when the CPA slides into the engaged position.

20. The first electrical connector of claim 13, wherein:
the sense leads are configured to be exposed in a slot of the first electrical connector; and
a shorting member of the CPA is configured to be disposed in the slot to make the electrical connection between the sense leads.

21. The first electrical connector of claim 13, wherein:
the CPA comprises a latch; and
the housing comprises a recess configured to retain the CPA by receiving the latch.

22. A method of connecting and disconnecting an electrical connector system including a first electrical connector, a second electrical connector, and a connector position assurance (CPA), the method comprising:
latching the first electrical connector to the second electrical connector by:
mating the first electrical connector to the second electrical connector in a mating direction; and engaging a latch of the first electrical connector with a complementary latching feature of the second electrical connector; and
electrically connecting a first sense lead to a second sense lead by sliding the CPA.

23. The method of claim 22, further comprising electrically disconnecting the first sense lead from the second sense lead by sliding the CPA.

24. The method of claim 23, wherein:
electrically connecting the first sense lead to the second sense lead by sliding the CPA comprises sliding the CPA in the mating direction; and
electrically disconnecting the first sense lead from the second sense lead by sliding the CPA comprises sliding the CPA in the mating direction.

25. The method of claim 24, further comprising actuating the latch in a direction perpendicular to the mating direction to unlatch the first electrical connector from the second electrical connector after electrically disconnecting the first sense lead from the second sense lead by sliding the CPA.

26. The method of claim 22, further comprising attaching the CPA to the first electrical connector.

27. The method of claim 26, wherein attaching the CPA to the first electrical connector comprises sliding the CPA in the mating direction.

28. The method of claim 27, further comprising disposing at least a portion of the CPA in a slot of the first electrical connector before attaching the CPA to the first electrical connector.

29-47. (canceled)
